(19) United States
(12) Patent Application Publication
(10) Pub. No.: US 2025/0021759 A1
(43) Pub. Date: Jan. 16, 2025

(54) ENCODING LOG-SPECIFIC ATTRIBUTES WITH NLP MODELS

(71) Applicant: Oracle International Corporation, Redwood Shores, CA (US)

(72) Inventors: Samuele Meta, Zurich (CH); Aneesh Dahiya, Zurich (CH); Felix Schmidt, Baden-Dattwil (CH); Marija Nikolic, Zurich (CH); Matteo Casserini, Zurich (CH); Milos Vasic, Zurich (CH)

(21) Appl. No.: 18/219,763

(22) Filed: Jul. 10, 2023

(51) Int. Cl. G06F 40/284; G06F 11/34

(52) U.S. Cl. CPC G06F 40/284; G06F 11/3476

(57) ABSTRACT

Herein is natural language processing (NLP) to detect an anomalous log entry using a language model that infers an encoding of the log entry from novel generation of numeric lexical tokens. In an embodiment, a computer extracts an original numeric lexical token from a variable sized log entry. Substitute numeric lexical token(s) that represent the original numeric lexical token are generated, such as with a numeric exponent or by trigonometry. The log entry does not contain the substitute numeric lexical token. A novel sequence of lexical tokens that represents the log entry and contains the substitute numeric lexical token is generated. The novel sequence of lexical tokens does not contain the original numeric lexical token. The computer hosts and operates a machine learning model that generates, based on the novel sequence of lexical tokens that represents the log entry, an inference that characterizes the log entry with unprecedented accuracy.

### FIELD OF THE INVENTION

The present invention relates to natural language processing (NLP). To facilitate detection of an anomalous log entry, a language model infers an encoding of the log entry from novel generation of numeric lexical tokens.

### BACKGROUND

Operation of a database may generate various log files for auditing and troubleshooting purposes. Information in a database diagnostic log (i.e. not a write ahead log) may include problems encountered during starting, running, and stopping, established client connections, statements received from clients, performance metrics and similar. This information may be valuable for machine learning (ML) algorithms that can be trained to perform database related tasks. ML solutions targeting such tasks help provide insights from raw telemetry data, automate decision processes, and strengthen business offerings.

Most state-of-the-art ML algorithms enable processing of numerical input data only. A database query log however is composed of messages with multiple fields, where a field may contain numerical data, categorical data, a database statement, or temporal information. Numeric attributes have values that describe a measurable quantity as a number and are thus quantitative variables. Numeric variables may be continuous or discrete. Continuous observations can take any value between a certain set of real numbers. Discrete observations can take a value based on a count from a set of distinct values.

There are various ways to encode log data for consumption by an ML model. The simplest way to represent categorical values as numbers is to assign a unique integer to each distinct value in the category. That method is simple but implies an ordering of categorical values, which in most cases has little (e.g. spectral colors) or no (e.g. tea flavors) semantic support. One Hot Encoding (OHE) solves the issue of implicit ordering by representing each category as a sparse vector that wastes space. The size of the vector is typically equal to the number of distinct possible values in the category. Each categorical value is uniquely represented by placing value one at the corresponding vector element, and zero values elsewhere in the vector. Drawbacks common to both of those methods are (i) inability of the methods to capture semantics, which subsequently affects the ML performance (i.e. decreases accuracy), and (ii) inability to deal with out-of-the-vocabulary (OOV) (i.e. new) words.

The success of natural language processing (NLP) representation learning methods motivates their use in encoding diagnostic logs as well, because log messages somewhat resemble natural text. Despite the effectiveness of NLP approaches in encoding textual data, the performance (i.e. accuracy) deteriorates when numbers are introduced in the data. For example on one numerically intensive log analytics benchmark, bidirectional encoder representations from transformers (BERT) performs five times worse when inferring an answer that is a number instead of prose. Since database query logs contain a vast amount of numerical data, it is not straightforward to generalize NLP models to handle numbers properly (i.e. accurately).

### BRIEF DESCRIPTION OF THE DRAWINGS

In the drawings:

FIG. 1 is a block diagram that depicts an example computer that uses natural language processing (NLP) techniques and novel generation of numeric lexical tokens from which a machine learning (ML) model generates an inference that, in an embodiment, may be a fixed-size encoding of a variable-sized log entry;

FIG. 2 is a flow diagram that depicts an example computer process that uses NLP techniques and novel generation of numeric lexical tokens from which an ML model generates an inference that, in an embodiment, may be a fixed-size encoding of a variable-sized log entry;

FIG. 3 is a block diagram that illustrates a computer system upon which an embodiment of the invention may be implemented;

FIG. 4 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

To facilitate detection of an anomalous log entry, herein is natural language processing (NLP) and a language model that infers an encoding of the log entry from novel generation of numeric lexical tokens. In an embodiment, log entries are first processed using dedicated transformations to extract information from log-specific fields, including transformation of numbers based on converting from decimal to scientific notation. For timestamps, trigonometric sine and cosine transformations help an ML algorithm understand (e.g. detect or infer based on) the periodic nature of recorded time. Log entries with transformed fields are then treated as a natural language sentence (i.e. sequence of tokens) and passed to an NLP method for encoding that may drive an important task such as anomaly detection on database activity. The methodology can however be extended to a variety of other tasks, and it is expected to generalize well to other log-related applications.

This approach has the following advantages.
Improved robustness of numerical values representation. Given the dynamic nature of a database, capturing the order of magnitude of a number is often more relevant than the number's exact value.
Improved robustness of timestamp values representation. After unpacking the original value into its main components (month, day of the week, etc.), the periodic nature of each of those components is preserved.
Combines strengths of transformations and NLP methods. Preprocessing transformations (i.e. not NLP transformers) herein are dedicated to the extraction of targeted information, which can be used by NLP methods. NLP can combine transformations and other logged diagnostic information, providing contextual representation learning.
Improved ML performance. For example in anomaly detection, false negatives are decreased (i.e. accuracy is increased).
Generalizable approach which can be applied to other types of logs that contain numbers and/or timestamps.
Good semantic representation.
Graceful handling of previously unseen data.
Stability of representations over time. Representations can incorporate changes in input data (e.g., new values for a category) and thus enable online learning (e.g., allow ML algorithms to dynamically adapt to new patterns). This approach is essentially future proof.

This approach has at least the following innovations.
A database query log entry encoder that transforms database query log-specific attributes into a form better suited for NLP methods and encodes them along with other attributes using an NLP encoder.
Training the log entry encoder on real-world structured query language (SQL) data for unprecedented accuracy.
Using the log entry encoder for anomaly detection.

In an embodiment, a computer extracts an original numeric lexical token from a variable sized log entry. Substitute numeric lexical token(s) that represent the original numeric lexical token are generated, such as with a numeric exponent or by trigonometry. The log entry does not contain the substitute numeric lexical token. A novel sequence of lexical tokens that represents the log entry and contains the substitute numeric lexical token is generated. The novel sequence of lexical tokens does not contain the original numeric lexical token. The computer hosts and operates a machine learning model that generates, based on the novel sequence of lexical tokens that represents the log entry, an inference that characterizes the log entry with unprecedented accuracy.

### 1.0 Example Computer

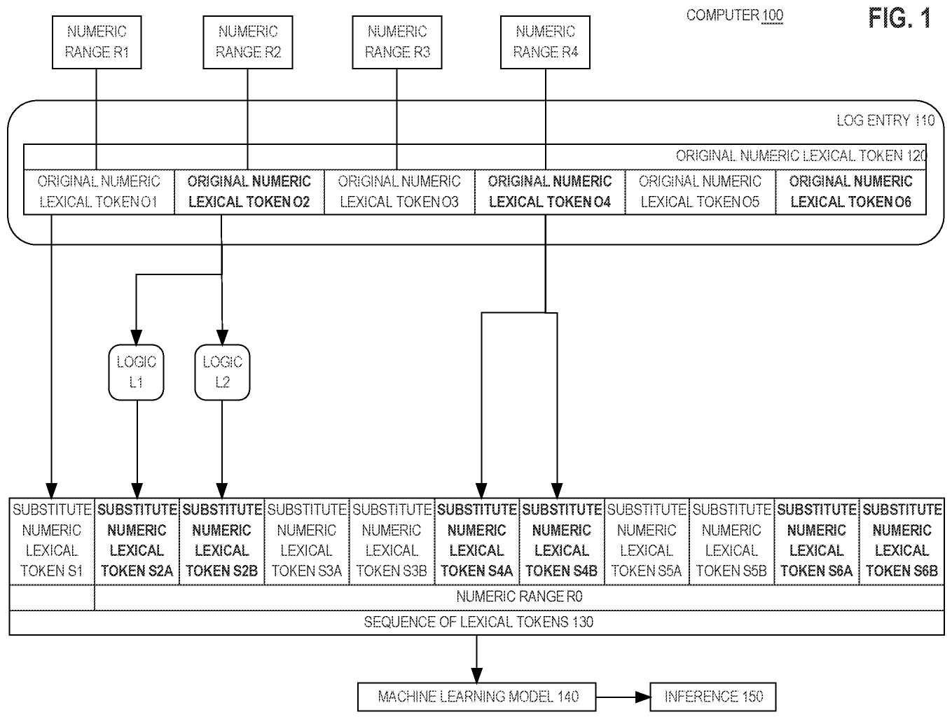

FIG. 1 is a block diagram that depicts an example computer 100 that uses natural language processing (NLP) techniques and novel generation of numeric lexical tokens from which machine learning (ML) model 140 generates inference 150 that, in an embodiment, may be a fixed-size encoding of variable-sized log entry 110. Computer 100 may be one or more of a rack server such as a blade, a personal computer, a mainframe, or a virtual computer.

Computer 100 may retrieve or monitor diagnostic or operational output such as telemetry and console output of a computer application. Depending on the embodiment, computer 100 may access a file, a database table, or a live stream to access many log entries emitted by a computer application such as a relational database management system (RDBMS).

### 1.1 Example Log Entry

Within a log (e.g. sequence) of entries is log entry 110 that may be a database record, a spreadsheet row, a line of text, or a semi-structured document such as JavaScript object notation (JSON) or extensible markup language (XML). Log entry 110 may contain multiple values (not shown), including original numeric lexical token 120 that is a numeric value encoded as text such as a number, an internet protocol (IP) address, or a timestamp. For example, computer 100 may use a parser to convert a numeric lexical token into a binary encoded number for numeric processing.

The following is an example log entry 110 that is text formatted as JavaScript object notation (JSON) that contains key-value pairs that characterize a structured query language (SQL) database statement and its execution. In various embodiments, keys are or are not included in sequence of lexical tokens 130 that is discussed later herein. In the following example log entry 110, the first key-value pair is a timestamp whose value may be original numeric lexical token 120 that, in this example, is the only timestamp in example log entry 110, which is not the only key-value pair in example log entry 110 that may be numerically transcoded as discussed later herein. In the following example log entry 110, many of the other key-values have values that are numeric and may be numerically transcoded, which entails conversion from an original number format to a substitute number format as discussed later herein.

{“timestamp”: “2023-02-03 10:14:51”, “id”: 3, “class”:
“general”, “event”: “status”, “connection_id”: 17, “account”: {
“user”: “demouser”, “host”: “host123.oracle.com” }, “login”: {
“user”: “demouser”, “os”: “”, “ip”: “123.234.123.100”, “proxy”:
“” }, “general_data”: { “command”: “Query”, “sql_command”:
“select”, “query”: “SELECT * FROM table1 JOIN table2 ON
table1.col1 = table2.col1 WHERE table1.col2 = 18”, “status”: 0
}, “query_statistics”: { “query_time”: 0.000325, “bytes_sent”:
4560, “bytes_received”: 169, “rows_sent”: 1, “rows_examined”:
2}}

### 1.2 Compound Original Lexical Token

In the example shown in FIG. 1, original numeric lexical token 120 is a compound (i.e. composite) token that may contain multiple (e.g. concatenated) component lexical tokens. That is, some lexical tokens, including some numeric ones, may be more or less decomposable into smaller (i.e. fewer characters) lexical tokens, possibly including some numeric ones. In an embodiment, decomposing a compound lexical token into multiple component lexical tokens does not entail copying text. In the shown embodiment, compound original numeric lexical token 120 contains at least six component original numeric lexical tokens O1-O6 that all have distinct semantics such as discussed below.

The component values of original numeric lexical token 120 are shown with so-called zebra stripes of alternating plain and bold text to demonstratively indicate that original numeric lexical tokens O1-O6 occur in a sequence whose ordering might matter. For example as shown and as discussed later herein, respective substitute numeric lexical token(s) are generated in sequence of lexical tokens 130 that is shown with demonstrative zebra stripes that correspond to the zebra stripes of original numeric lexical tokens O1-O6. For example, substitute numeric lexical tokens S2A-S2B are shown bold to indicate that substitute numeric lexical tokens S2A-S2B are (e.g. indirectly) based on corresponding bold original numeric lexical token O2 as discussed later herein.

### 1.3 Human Readable Timestamp

In the shown example, original numeric lexical token 120 may be an American timestamp literal such as “2023 Feb. 14 20:14:51”, not including quotes. Numeric lexical tokens herein are enclosed in, but do not include, quotes. Original numeric lexical tokens O1-O6 may respectively be a year; a month, a day, an hour, minutes, and seconds. In this example, original numeric lexical tokens 120 and O1-O6 are decimal (i.e. base ten) encoded text that are human readable as number(s). In an example not shown, a compound numeric lexical token may be an IP address that contains multiple (e.g. four) octal, decimal, or hexadecimal integers. Some numeric lexical tokens may instead be a fixed or floating point real number, such as money or a performance statistic such as an average. In an embodiment, an original numeric lexical token may be an integer whose value exceeds five million.

### 1.4 Substitute Numeric Lexical Token

In this example, each of original numeric lexical tokens O1-O6 is transcoded (i.e. transformed) into one or two other numeric lexical tokens that represent (i.e. encode) a same number. For example, original numeric lexical token O1 may be “2023” that is a decimal year that may be transformed to generate a scientific number “2.023E3”, shown as substitute numeric lexical token S1 that contains a numeric exponent even though original numeric lexical token O1 lacks an exponent.

Substitute numeric lexical token S1 does not lexically reflect original numeric lexical token O1. For example, “2.023E3” is lexically different from “2023” that are two very different literals.

Substitute numeric lexical token S1 does not lexically (i.e. literally) represent original numeric lexical token O1 but instead only semantically represents original numeric lexical token O1. In other words numeric lexical tokens S1 and O1 are semantically equivalent but not literally equivalent. Thus, transcoding herein preserves semantic content. In an embodiment, the numeric precision of substitute numeric lexical token S1 may be less than that of corresponding original numeric lexical token O1, which may conserve memory or prevent overfitting (i.e. increase accuracy) of machine learning (ML) model 140.

Herein, lexical token means a numeric literal, an alphanumeric literal, whitespace, punctuation, or a quoted literal. Lexical tokens herein may or may not correspond to tokens that are native to ML model 140. For example, computer 100 and ML model 140 may have same or different tokenization rules. In an embodiment, ML model 140 accepts sequence of tokens 130 as direct input. In an embodiment, ML model 140 instead accepts a textual concatenation of sequence of tokens 130 as a monolithic input string that ML model 140 decomposes into its own tokens in its own way.

### 1.5 Kinds of Numeric Ranges

Original numeric lexical token O1 is a monotonically increasing year. In other words, a unique year does not repeat in nature because years are aperiodic (i.e. not periodic; non-repeating). That is, years do not roll over or wrap around as time progresses. A single numeric lexical token is sufficient to represent any aperiodic numeric lexical token.

An aperiodic numeric lexical token may be more or less continuous. A numeric range that has defined gaps (e.g. integer instead of real) is nonetheless continuous herein so long as the numeric range is monotonic (e.g. integer). Herein, a sawtooth range is a numeric range that is discontinuous despite periodically repeating, which may confuse ML model 140. For example, original numeric lexical token O2 may be a zero or one based month integer that wraps around (i.e. resets to zero or one) for a January that is adjacent to a December, which is discontinuous and confusing. For example, ML model 140 may learn that adjacent months are adjacent integers. For example, December may be integer month twelve and adjacent November may be adjacent integer eleven, but adjacent January rolls over (i.e. resets) to one, which is not an adjacent integer and thus discontinuous.

1.6 Multiple Substitute Tokens from Single Original Token

Periodic ranges herein may be cyclic (i.e. continuous) or instead sawtooth with a periodic discontinuous reset to an initial value such as zero or one. Thus herein, periodic may or may not mean cyclic and, herein, cyclic and sawtooth are mutually exclusive periodic examples. Herein, one original numeric lexical token that is sawtooth (i.e. periodic and discontinuous) is transformed into two substitute numeric lexical tokens that both are cyclic (i.e. continuous). For example, sawtooth original numeric lexical token O2 may be a month integer that is transformed into two cyclic and continuous substitute numeric lexical tokens S2A-S2B.

Substitute numeric lexical tokens S2A-S2B together represent (i.e. are semantically equivalent to) original numeric lexical token O2 despite none of numeric lexical tokens S2A-S2B and O2 being lexically equivalent. In other words, all three of numeric lexical tokens S2A-S2B and O2 are lexically distinct literals.

### 1.7 Novel Sequence of Tokens

Although substitute numeric lexical tokens S2A-S2B are less dense (i.e. less compact; need more space) than original numeric lexical token O2, a benefit of substitute numeric lexical tokens S2A-S2B is that, unlike original numeric lexical token O2, they are continuous instead of sawtooth, which increases the accuracy of ML model 140. Thus, specially generated sequence of lexical tokens 130 is longer (i.e. contains more tokens) but more accurate than a naïve sequence of lexical tokens would be if generated to instead actually contain original numeric lexical tokens O1-O6.

For example with naïve tokenization, original numeric lexical tokens O1-O6 may be directly used as a dense sequence of six numeric lexical tokens that is less accurate than improved and semantically equivalent sequence of lexical tokens 130 that instead has eleven numeric lexical tokens. In other words, improved sequence of lexical tokens 130 contains synthetic tokens that are additional numeric tokens, and the naïve sequence would instead not contain synthetic tokens.

For simplicity of demonstration, not all details are shown in FIG. 1. For example, substitute numeric lexical tokens S1 and S2A-S2B are shown as generated from original numeric lexical tokens O1-O2. Likewise, substitute numeric lexical tokens S3A-S3B, S4A-S4B, S5A-S5B, and S6A-S6B may be generated from original numeric lexical tokens O3-O6.

Not shown are other (e.g. compound or not) numeric and non-numeric lexical tokens in log entry 110. Thus, sequence of lexical tokens 130 may additionally contain unshown numeric and non-numeric lexical tokens. For example, sequence of lexical tokens 130 may contain tens or hundreds of numeric lexical tokens.

Log entry 110 may contain a non-numeric lexical token that has a categoric value such as a month by name such as February. A categoric text value may or may not be naturally periodic or aperiodic. For example, months are periodic but colors are aperiodic. Distinct values of an aperiodic category may be treated as distinct integers that each may be encoded as a single integer numeric lexical token that may or may not be encoded in scientific notation in sequence of lexical tokens 130.

### 1.8 Trigonometric Transcoding

Distinct periodic values of a category may be treated as distinct integers that each may be trigonometrically transcoded into, for example, two substitute real numeric lexical tokens S2A-S2B as discussed earlier herein. Substitute numeric lexical tokens S2A-S2B may have distinct values even though both are based on same original numeric lexical token O2, and substitute numeric lexical tokens S2A-S2B may be separately calculated by respective distinct logics L1-L2 as shown. For example, logic L1 may entail sine, and logic L2 may entail cosine, both of which are trigonometric continuous functions. The following are respective example implementations of logics L1-L2.

$${x}_{sin} = sin ( \frac{2 π x}{max ( x )} ) , {x}_{cos} = cos ( \frac{2 π x}{max ( x )} )$$

In the above example implementations of logics L1-L2, the following terms have the following meanings.
x is any of cyclic original numeric lexical tokens O1-O6.
max(x) is based on an original numeric range such as R1-R4.
xₛᵢₙ and x_{cos} are two adjacent tokens in sequence of lexical tokens 130 such as substitute numeric lexical tokens S2A-S2B, S3A-S3B, S4A-S4B, S5A-S5B, or S6A-S6B.

### 1.9 Universal Sawtooth Transcoding

In an (e.g. trigonometric) embodiment, logics L1-L2 do not use a modulus (i.e. a divisor to obtain a remainder) nor a modulo operator (i.e. to obtain a remainder by division). Because categoric values may be transcoded into integers and/or because each sawtooth number may be transcoded into multiple real numbers, sequence of lexical tokens 130 may contain more numeric lexical tokens than non-numeric lexical tokens.

Sine an cosine share a same cyclic (i.e. continuous) numeric range R0 that may be shared by all of substitute numeric lexical tokens S2A-S2B, S3A-S3B, S4A-S4B, S5A-S5B, and S6A-S6B. In this trigonometric example, numeric range R0 of substitute numeric lexical tokens S2A-S2B is inclusively from negative one to positive one, even though numeric range R2 of original numeric lexical token O2 may or may not include a value that is less than, more than, or within numeric range R0. In other words, numeric ranges R0 and R2 may be uncorrelated.

In the shown example, at least four original numeric lexical tokens O1-O4 have respective distinct numeric ranges R1-R4. Two distinct numeric ranges may or may not partially overlap. For example, month numeric range R2 and day of month numeric range R3 have a same minimum value but different maximum values, even though both numeric ranges R2-R3 are cyclic.

In the shown example, original numeric lexical token 120 is a compound timestamp, and substitute numeric lexical tokens S2A-S2B, S3A-S3B, S4A-S4B, S5A-S5B, and S6A-S6B all have same numeric range R0, even though numeric ranges R1-R4 are distinct. In this example, original numeric lexical tokens O5-O6 are the only two that share a numeric range (not shown), because minutes and seconds naturally have a same range.

For example, logics L1-L2 may or may not be reused to generate all of substitute numeric lexical tokens S2A-S2B, S3A-S3B, S4A-S4B, S5A-S5B, and S6A-S6B. Sine and cosine may be used to transcode from any periodic numeric range and, especially, any sawtooth numeric range. When used together herein, sine and cosine are universal transcoders to achieve a universal cyclic and continuous range for all sawtooth (i.e. noncontinuous) numeric ranges.

### 2.0 Example Training and Inferencing Process

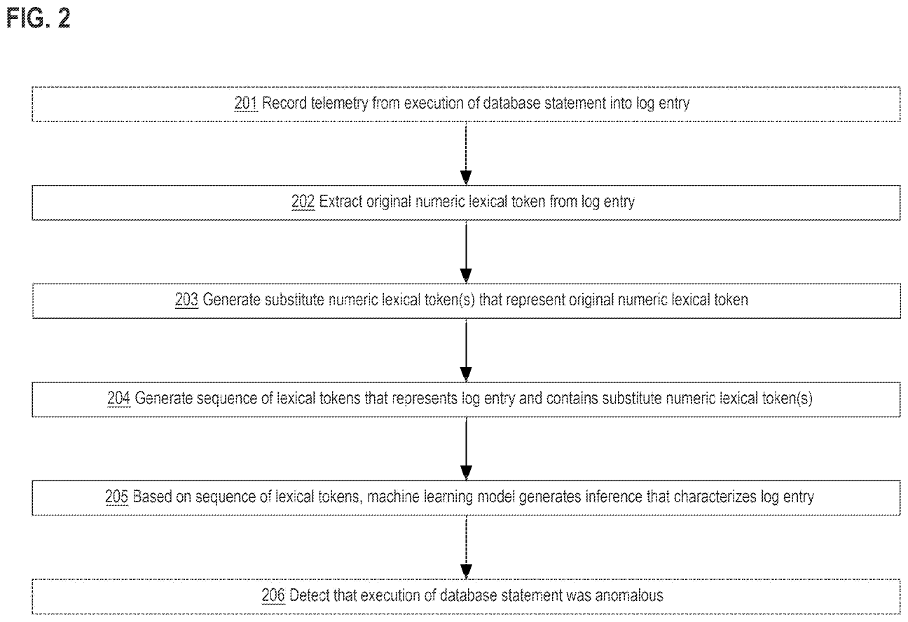

FIG. 2 is a flow diagram that depicts an example process that computer 100 may perform using natural language processing (NLP) techniques and novel generation of numeric lexical tokens from which machine learning (ML) model 140 generates inference 150 that, in an embodiment, may be a fixed-size encoding of variable-sized log entry 110.

Steps 201 and 206 are application specific to database security in an embodiment. Steps 201 and 206 are optional or replaced or unimplemented in various embodiments that, for example, do not entail a database and/or security.

In an embodiment that implements step 201, step 201 records, into log entry 110, telemetry that characterizes a database statement and its execution into log entry 110 as discussed earlier herein. Step 201 may, for example, occur on a different computer and/or much earlier than steps 202-206. From the perspective of steps 202-206 in an archival embodiment, step 201 occurred in the past and is historic. In a streaming embodiment, log entry 110 instead may be live and processed by all steps 201-206 in real time.

Step 202 extracts an original numeric lexical token from log entry 110, such as original numeric lexical token O1 or O2. Extraction by step 202 may entail copying text, scanning text, and/or identifying a multicharacter span within text. In an embodiment, step 202 does not copy text.

Step 203 generates substitute numeric lexical token(s) that represent the original numeric lexical token. For example when transcoding an aperiodic year, step 203 may generate only substitute numeric lexical token S1 from original numeric lexical token O1. When transcoding a cyclic month, step 203 may instead generate both substitute numeric lexical tokens S2A-S2B from original numeric lexical token O2.

Step 203 may occur as a sub-step of step 204 that generates sequence of lexical tokens 130 that represents log entry 110 and contains substitute numeric lexical tokens S1, S2A-S2B, S3A-S3B, S4A-S4B, S5A-S5B, and S6A-S6B. Sequence of lexical tokens 130 may contain some lexical tokens that originally occur in log entry 110. For example, numeric transcoding herein may not or should not occur for some string literal values in log entry 110, and those values not transcoded may instead be directly included as is into sequence of lexical tokens 130.

Based on sequence of lexical tokens 130, machine learning (ML) model 140 generates inference 150 that characterizes log entry 110 in step 205. Depending on the embodiment, inference 150: a) is or is not an encoding (e.g. embedding) of log entry 110 and b) is or is not fixed size even though log entry 110 itself might be variable sized. For example if ML model 140 is based on an open source language model such as bidirectional encoder representations from transformers (BERT) or FastText, then inference 150 may be a fixed size encoding of log entry 110. In any case, the count of lexical tokens in sequence of lexical tokens 130 may be more or less linearly proportional to a count of values (i.e. original lexical tokens) in log entry 110. That is, both of components 110 and 130 may be variable sized.

In an embodiment that implements step 206, step 206 detects that execution of the database statement of step 201 was anomalous. For example, online analytic processing (OLAP) may entail a table scan that accesses many rows in a relational table, but only a few or one row are typically accessed by online transaction processing (OLTP). In the example log entry 110 presented earlier herein, rows_examined may be a key-value pair with a value that is a count of rows accessed, which step 206 may detect as excessively high or low depending on static characteristics of the database statement, such as OLAP or OLTP.

An (e.g. a second ML model that is downstream of ML model 140) anomaly detector (not shown) may accept inference 150 as input to generate a second inference that row_examined is excessive and/or that log entry 110 (and inference 150) is anomalous. In an embodiment, ML model 140 is or contains the anomaly detector, and inference 150 is a binary classification that log entry 110 is anomalous or non-anomalous, or inference 150 is an anomaly score (e.g. probability) that indicates how likely is log entry 110 to be anomalous. For example, step 206 may compare anomaly score inference 150 to a predefined threshold to detect that log entry 110 is anomalous.

### 3.0 Database Overview

Embodiments of the present invention are used in the context of database management systems (DBMSs). Therefore, a description of an example DBMS is provided.

Generally, a server, such as a database server, is a combination of integrated software components and an allocation of computational resources, such as memory, a node, and processes on the node for executing the integrated software components, where the combination of the software and computational resources are dedicated to providing a particular type of function on behalf of clients of the server. A database server governs and facilitates access to a particular database, processing requests by clients to access the database.

Users interact with a database server of a DBMS by submitting to the database server commands that cause the database server to perform operations on data stored in a database. A user may be one or more applications running on a client computer that interact with a database server. Multiple users may also be referred to herein collectively as a user.

A database comprises data and a database dictionary that is stored on a persistent memory mechanism, such as a set of hard disks. A database is defined by its own separate database dictionary. A database dictionary comprises metadata that defines database objects contained in a database. In effect, a database dictionary defines much of a database. Database objects include tables, table columns, and tablespaces. A tablespace is a set of one or more files that are used to store the data for various types of database objects, such as a table. If data for a database object is stored in a tablespace, a database dictionary maps a database object to one or more tablespaces that hold the data for the database object.

A database dictionary is referred to by a DBMS to determine how to execute database commands submitted to a DBMS. Database commands can access the database objects that are defined by the dictionary.

A database command may be in the form of a database statement. For the database server to process the database statements, the database statements must conform to a database language supported by the database server. One non-limiting example of a database language that is supported by many database servers is SQL, including proprietary forms of SQL supported by such database servers as Oracle, such as Oracle Database 11g. SQL data definition language (“DDL”) instructions are issued to a database server to create or configure database objects, such as tables, views, or complex types. Data manipulation language (“DML”) instructions are issued to a DBMS to manage data stored within a database structure. For instance, SELECT, INSERT, UPDATE, and DELETE are common examples of DML instructions found in some SQL implementations. SQL/XML is a common extension of SQL used when manipulating XML data in an object-relational database.

A multi-node database management system is made up of interconnected nodes that share access to the same database. Typically, the nodes are interconnected via a network and share access, in varying degrees, to shared storage, such as with shared access to a set of disk drives and data blocks stored thereon. The nodes in a multi-node database system may be in the form of a group of computers, such as work stations and/or personal computers, that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

### 3.1 Query Processing

A query is an expression, command, or set of commands that, when executed, causes a server to perform one or more operations on a set of data. A query may specify source data object(s), such as table(s), column(s), view(s), or snapshot(s), from which result set(s) are to be determined. For example, the source data object(s) may appear in a FROM clause of a Structured Query Language (“SQL”) query. SQL is a well-known example language for querying database objects. As used herein, the term “query” is used to refer to any form of representing a query, including a query in the form of a database statement and any data structure used for internal query representation. The term “table” refers to any source object that is referenced or defined by a query and that represents a set of rows, such as a database table, view, or an inline query block, such as an inline view or subquery.

The query may perform operations on data from the source data object(s) on a row by-row basis as the object(s) are loaded or on the entire source data object(s) after the object(s) have been loaded. A result set generated by some operation(s) may be made available to other operation(s), and, in this manner, the result set may be filtered out or narrowed based on some criteria, and/or joined or combined with other result set(s) and/or other source data object(s).

A subquery is a portion or component of a query that is distinct from other portion(s) or component(s) of the query and that may be evaluated separately (i.e., as a separate query) from the other portion(s) or component(s) of the query. The other portion(s) or component(s) of the query may form an outer query, which may or may not include other subqueries. A subquery nested in the outer query may be separately evaluated one or more times while a result is computed for the outer query.

Generally, a query parser receives a query statement and generates an internal query representation of the query statement. Typically, the internal query representation is a set of interlinked data structures that represent various components and structures of a query statement.

The internal query representation may be in the form of a graph of nodes, each interlinked data structure corresponding to a node and to a component of the represented query statement. The internal representation is typically generated in memory for evaluation, manipulation, and transformation.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

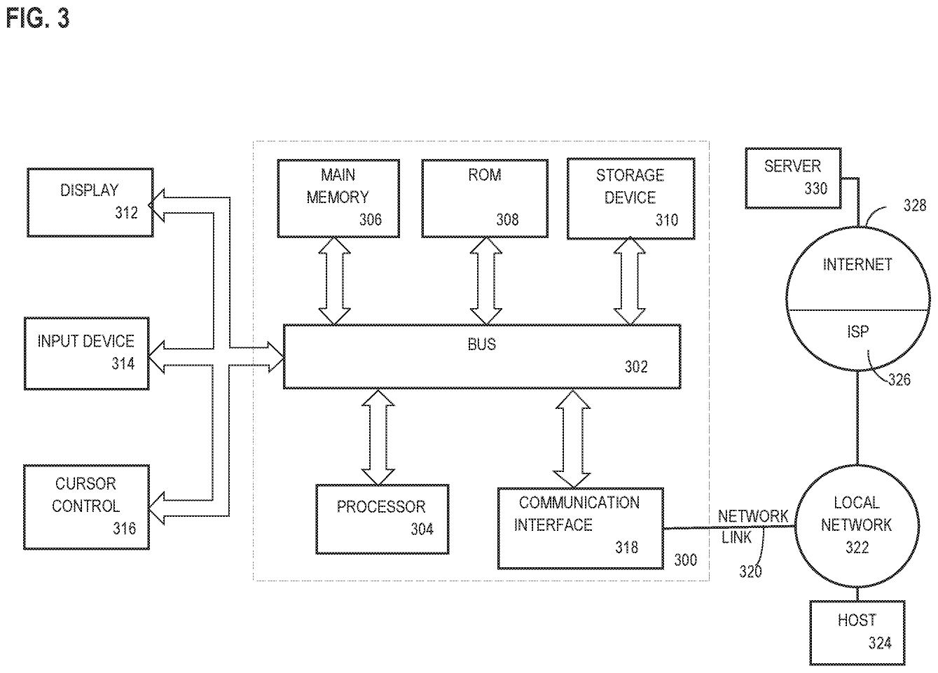

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

### Software Overview

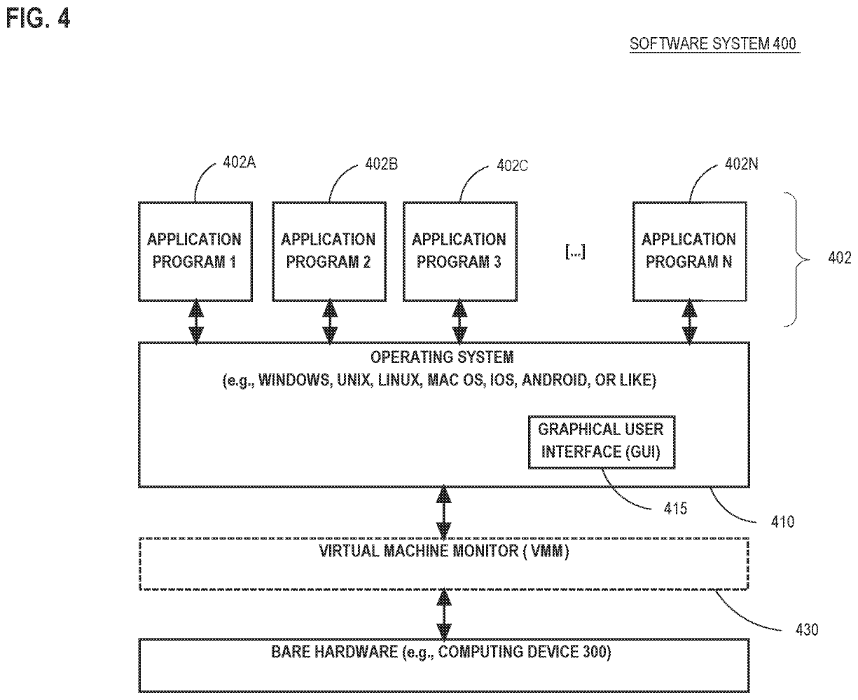

FIG. 4 is a block diagram of a basic software system 400 that may be employed for controlling the operation of computing system 300. Software system 400 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 400 is provided for directing the operation of computing system 300. Software system 400, which may be stored in system memory (RAM) 306 and on fixed storage (e.g., hard disk or flash memory) 310, includes a kernel or operating system (OS) 410.

The OS 410 manages low-level aspects of computer operation, including managing execution of processes, memory allocation, file input and output (I/O), and device I/O. One or more application programs, represented as 402A, 402B, 402C . . . 402N, may be “loaded” (e.g., transferred from fixed storage 310 into memory 306) for execution by the system 400. The applications or other software intended for use on computer system 300 may also be stored as a set of downloadable computer-executable instructions, for example, for downloading and installation from an Internet location (e.g., a Web server, an app store, or other online service).

Software system 400 includes a graphical user interface (GUI) 415, for receiving user commands and data in a graphical (e.g., “point-and-click” or “touch gesture”) fashion. These inputs, in turn, may be acted upon by the system 400 in accordance with instructions from operating system 410 and/or application(s) 402. The GUI 415 also serves to display the results of operation from the OS 410 and application(s) 402, whereupon the user may supply additional inputs or terminate the session (e.g., log off).

OS 410 can execute directly on the bare hardware 420 (e.g., processor(s) 304) of computer system 300. Alternatively, a hypervisor or virtual machine monitor (VMM) 430 may be interposed between the bare hardware 420 and the OS 410. In this configuration, VMM 430 acts as a software “cushion” or virtualization layer between the OS 410 and the bare hardware 420 of the computer system 300.

VMM 430 instantiates and runs one or more virtual machine instances (“guest machines”). Each guest machine comprises a “guest” operating system, such as OS 410, and one or more applications, such as application(s) 402, designed to execute on the guest operating system. The VMM 430 presents the guest operating systems with a virtual operating platform and manages the execution of the guest operating systems.

In some instances, the VMM 430 may allow a guest operating system to run as if it is running on the bare hardware 420 of computer system 300 directly. In these instances, the same version of the guest operating system configured to execute on the bare hardware 420 directly may also execute on VMM 430 without modification or reconfiguration. In other words, VMM 430 may provide full hardware and CPU virtualization to a guest operating system in some instances.

In other instances, a guest operating system may be specially designed or configured to execute on VMM 430 for efficiency. In these instances, the guest operating system is “aware” that it executes on a virtual machine monitor. In other words, VMM 430 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N [L−1] and N [L], respectively, the dimensions of matrix W is N [L−1] columns and N [L] rows.

Biases for a particular layer L may also be stored in matrix B having one column with N [L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2 (1): 1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
extracting an original numeric lexical token from a log entry;
first generating a substitute numeric lexical token that represents the original numeric lexical token, wherein the log entry does not contain the substitute numeric lexical token;
second generating a sequence of lexical tokens that represents the log entry and contains the substitute numeric lexical token, wherein the sequence of lexical tokens does not contain the original numeric lexical token; and
third generating, by a machine learning model and based on the sequence of lexical tokens that represents the log entry and contains the substitute numeric lexical token that represents the original numeric lexical token, an inference that characterizes the log entry.

2. The method of claim 1 wherein said first generating comprises generating the substitute numeric lexical token and a second substitute numeric lexical token that together represent the original numeric lexical token.

3. The method of claim 2 wherein the substitute numeric lexical token and the second substitute numeric lexical token have identical numeric ranges.

4. The method of claim 3 wherein the substitute numeric lexical token and the second substitute numeric lexical token are calculated by distinct respective logics.

5. The method of claim 2 wherein only one of the original numeric lexical token and the second substitute numeric lexical token exceeds one.

6. The method of claim 1 wherein the log entry contains a second original numeric lexical token that contains a concatenation of the original numeric lexical token and a third original numeric lexical token.

7. The method of claim 6 wherein said concatenation contains at least six numeric lexical tokens.

8. The method of claim 7 wherein at least one selected from a group consisting of:
said at least six numeric lexical tokens have distinct respective semantics, and at least four of said at least six numeric lexical tokens have distinct respective numeric ranges.

9. The method of claim 6 wherein:
the original numeric lexical token and the third original numeric lexical token have distinct respective numeric ranges;
the sequence of lexical tokens contains:
first multiple substitute numeric lexical tokens that are based on the original numeric lexical token, and
second multiple substitute numeric lexical tokens that are based on the third original numeric lexical token; and
the first multiple substitute numeric lexical tokens and the second multiple substitute numeric lexical tokens share a single numeric range.

10. The method of claim 1 wherein:
a length of the sequence of lexical tokens depends on a count of values in the log entry; and
the inference is a fixed-sized encoding that represents the log entry.

11. The method of claim 10 wherein the log entry represents at least one selected from a group consisting of a security anomaly and an execution of a database statement.

12. The method of claim 1 wherein at least one selected from a group consisting of:
said first generating does not entail a modulus,
said first generating entails a continuous function, and
said first generating entails trigonometry.

13. The method of claim 1 wherein the sequence of lexical tokens contains at least one selected from a group consisting of:
multiple tokens that together represent the substitute numeric lexical token, and
more numeric lexical tokens than non-numeric lexical tokens.

14. The method of claim 1 wherein the original numeric lexical token and the substitute numeric lexical token have distinct respective numeric precisions.

15. The method of claim 1 wherein only one of the original numeric lexical token and the substitute numeric lexical token contains an exponent.

16. One or more non-transitory computer-readable media storing instructions that, when executed by one or more processors, cause:
extracting an original numeric lexical token from a log entry;
first generating a substitute numeric lexical token that represents the original numeric lexical token, wherein the log entry does not contain the substitute numeric lexical token;
second generating a sequence of lexical tokens that represents the log entry and contains the substitute numeric lexical token, wherein the sequence of lexical tokens does not contain the original numeric lexical token; and
third generating, by a machine learning model and based on the sequence of lexical tokens that represents the log entry and contains the substitute numeric lexical token that represents the original numeric lexical token, an inference that characterizes the log entry.

17. The one or more non-transitory computer-readable media of claim 16 wherein said first generating comprises generating the substitute numeric lexical token and a second substitute numeric lexical token that together represent the original numeric lexical token.

18. The one or more non-transitory computer-readable media of claim 16 wherein the log entry contains a second original numeric lexical token that contains a concatenation of the original numeric lexical token and a third original numeric lexical token.

19. The one or more non-transitory computer-readable media of claim 16 wherein:
a length of the sequence of lexical tokens depends on a count of values in the log entry; and
the inference is a fixed-sized encoding that represents the log entry.

20. The one or more non-transitory computer-readable media of claim 16 wherein the sequence of lexical tokens contains at least one selected from a group consisting of:
multiple tokens that together represent the substitute numeric lexical token, and
more numeric lexical tokens than non-numeric lexical tokens.
